(19) United States
(12) Patent Application Publication
(10) Pub. No.: US 2011/0125593 A1
(43) Pub. Date: May 26, 2011

(54) ONLINE MARKETING PAYMENT MONITORING METHOD AND SYSTEM

(75) Inventors: Robert Wright, Celebration, FL (US); David M. Schrader, Windermere, FL (US); Dale Couch, Orlando, FL (US); Robert Charest, Orlando, FL (US); Anibal Santiago, Orlando, FL (US); William McDonald, Clermont, FL (US); Edward H. Benson, III, Celebration, FL (US); Josh Griffin, Kissimmee, FL (US); Robert Sefick, Longwood, FL (US); Mark Ebel, Denville, NJ (US)

(73) Assignee: Channel Intelligence, Inc., Celebration, FL (US)

(21) Appl. No.: 12/675,747

(22) PCT Filed: Sep. 2, 2008
(86) PCT No.: PCT/US08/75039

§ 371 Date: Dec. 8, 2010

Related U.S. Application Data
(60) Provisional application No. 60/968,947, filed on Aug. 30, 2007.

(51) Int. Cl. G06Q 30/00; G06F 15/16

(52) U.S. Cl. 705/14.73; 705/27.1; 709/224

(57) ABSTRACT

A method of collecting and correlating information about user interactions with a plurality of websites including adding a first cookie from a first website, the first cookie recording information concerning interactions of a user with the first website; adding a second cookie from a second website, the second cookie recording information concerning interactions of the user with the second website; initiating a tracking pixel on a third website; capturing information from the first and second cookie; and determining a first contribution of the first website and a second contribution of the second website to interests in the third website.

### CROSS-REFERENCE TO RELATED APPLICATIONS

This application is a national stage of PCT Patent Application No. PCT/US08/075,039 filed Sep. 2, 2008, which claims the benefit of U.S. Provisional Patent Application No. 60/968,947 filed Aug. 30, 2007. The foregoing PCT and provisional applications are hereby incorporated by reference to the same extent as though fully disclosed herein.

### BACKGROUND OF THE INVENTION

The Online Marketing Payment Monitoring System relates to the field of e-commerce. Specifically, this application relates to the online marketing and analytic component of e-commerce as used by retailers such Amazon, Wal-Mart, Best Buy, Target and other larger—and smaller—retailers such as those that sell in the Amazon and other online market places. One aspect of the field includes individuals, partnerships, or corporation that compensate online marketing vehicles, such as America Online, Yahoo, Price Grabber or other firms, that are paid a percentage of sales to promote products via their online web sites.

A specific problem exists in online marketing: online retailers of all sizes pay online marketing sites (such as AOL, MSN, Yahoo, Price Grabber, and many more) a percentage of sales that are attributed to the marketing efforts of these sites (typically 4% to 5%) as compensation for these sites to display the retailer's products. In addition, the online marketing sites also typically are compensated for any sales that these same consumers make at the previously featured retailer in the next 14 to 30 days, independent of the activities of the consumer after visiting the online marketing site. This means that, for 30 days after visiting an online marketing site, the consumer will generate a commission to the online marketing site. To track this consumer, most online marketing sites use a “Cookie” or “tag” technology that will allow the e-commerce sites to recognize the consumer's buying activities for the next 30 days (or other agreed upon amount of time).

The problem is that consumers typically visit a large number of online marketing sites when researching products, especially during the Christmas shopping season. While the agreements between online marketing web sites (Yahoo, AOL and more) and e-commerce sites (Target.com, bestbuy.wrn, walmart.com, etc.) typically point out that in the case of a sale by a consumer that has visited many online marketing sites, that only the most recent or relevant online marketing site should be compensated, in practice this is very hard to monitor. We know of no application/product or service that can tell an e-commerce site that an individual (or group of) transactions had “tags” or “cookies” from more than one online marketing sites and if they did, what is the right online marketing site to compensate. Thus, most e-commerce sites double or triple pay for online marketing efforts that they should not. A technology is needed that can eliminate double (or triple or more) payments from unintentional requests for payment from online marketing firms, as well as a technology that can stop intentional fraud.

As mentioned above, retail sites like Walmart.com, Target.com, and more agree to pay a percent of sales to several “online marketing” web sites such as MSN.com, AOL.com and more; and to “track” this information, online marketing sites place “cookies” or other similar tracking products on consumers' computers when they visit an online marketing site such as AOL.com. The cookie contains information such as the time and date when the customer visited AOL.com. This process of having a “cookie” or other tracking software is repeated for every online marketing web site that the consumer visits. Agreements between online retailers and online marketing sites have rules about payments to multiple online marketing sites. Usually, the site that the consumer visited closest in time to the actual sale is paid—with other online marketing sites not being compensated. However, when consumers buy a product, the “buy” page of the online marketing web site tells all valid cookies on the consumer's hard drive that a sale occurred. All online marketing sites record the sale, and all send duplicate bills to the retailer to be paid a commission. Online retailers desire to eliminate this type of duplicate payment.

Larger retailers know of the above problem, but there is no solution that is in place that we are aware of—each retailer would need to develop their own solution, which would have a high cost per retailer. A system and method for eliminating multiple payments for online retailers with CPA online marketing programs is needed.

A system and method are needed to track online sales that are for all sales that the retailer has on their online site. Also, a system and method are needed that allows the online retailer to have detailed reporting of the sales and the metrics around every sale. The retailer desires to be able to determine the route used by the consumer in the process to buy something from their web site, so the online retailer may be able to do something completely new—offer partial compensation to online marketing sites as a way to increase sales.

The idea of not paying two or three times for the same thing is the basis for this issue. However, with a web site, it has been thought to be impossible to understand the traffic or sales that one online marketing web site brings to an online retailer. To date, the most common method of trying to understand the impact of sales that an online marketing site has to an online retailer is to shut the online marketing site off for a period of days or weeks. The thought is that the overall sales should drop, and then the macro percentage of the drop would be the impact of the online marketing site. However, most of these tests need to occur at the low sales period of the year so as not to hurt overall sales. It also only provides a very rough macro perspective—not the impact of individual online marketing sites on an individual product but an individual consumer perspective. A technology is needed that enables a completely new type of compensation agreements with online marketing sites and online retailers, so that the exact contribution of sales can be measured.

The best estimates in the online marketing/online retailer industry is that somewhere from 30% to 70% of all sales that are driven by these online performance programs are double or triple paid. A technology is needed for other online purposes that enables online marketing costs to be reduced by 10% to 30% for online retailers or more.

### BRIEF SUMMARY OF THE INVENTION

In one embodiment, a method of collecting and correlating information about user interactions with a plurality of websites includes creating a first tracking record of first actions of a user in relation to a first advertising webpage; loading a tracking pixel and a vendor webpage; capturing a second tracking record concerning second actions by the first user on the vendor webpage using the tracking pixel; and correlating the first and second tracking record to determine the contribution of the first advertising webpage to the second actions of the first user. In one alternative, the first tracking record is created by sending a first cookie to the user, wherein the first cookie is received by a computing device related to the user. In another alternative, the method also includes capturing the first tracking record from the computing device belonging to the first user, wherein the first tracking record is captured from the first cookie. In another alternative, the first tracking record captured is sent by the tracking pixel to a server. In another alternative, the correlating occurs at the server. In yet another alternative, the server analyzes the first and second tracking records and awards attribution for an occurrence of an event related to the loading of the vendor webpage. In another alternative, the event is a sale and the vendor webpage is a sale confirmation page. In another alternative, a third tracking record related to a second advertising webpage is created. In an alternative, the third tracking record is a second cookie. In another alternative, the server also analyzes the third tracking record in relation to the first and second tracking records. In another alternative, the attribution is awarded to a contributing website for the first and second advertiser webpage based on the temporal occurrence of the first and third tracking records. In another alternative, an advertising tracking pixel on the first advertising webpage performs the creating and sends the first tracking record to a server. In yet another alternative, the advertising tracking pixel captures information concerning the user accessing the first advertising website. In another alternative, the correlating occurs at the server. In yet another alternative, the server analyzes the first and second tracking records and awards attribution for an occurrence of an event related to the loading of the vendor webpage.

In one embodiment, a method of collecting and correlating information about user interactions with a plurality of websites includes distributing a plurality of first tracking pixels to a plurality of marketer websites; capturing a first set of information concerning actions of a plurality of users via the plurality of first tracking pixels; firing a tracking pixel on a vendor webpage; capturing a second set of information concerning a transaction by a user on the vendor webpage; and correlating the first set of information to the second set of information to determine a subset of the actions of the plurality of users related to the transaction. In one alternative, the correlating includes identifying a set of the actions of the plurality of users that correspond to the user and including those in the subset. In one alternative, the identifying is based on captured IP addresses.

In another alternative, the identifying is based on captured user-agent information. In another alternative, the identifying is based on captured session IDs. In another alternative, the identifying is based on captured cookie information. In another alternative, the transaction is the purchase of an item. In another alternative, the actions are product searches at a marketing website. In another alternative, the actions are the reception of advertisements.

In one embodiment, a method of collecting and correlating information about user interactions with a plurality of websites includes creating a plurality of tracking records concerning actions of a plurality of users in respect to a plurality of marketing webpages; loading a tracking pixel and a vendor webpage; capturing a second set of information concerning a transaction by a first user on the vendor webpage using the tracking pixel; and correlating at least a portion of the plurality of tracking records to the second set of information to determine a subset of the actions of the plurality of users related to the transaction. In one alternative, the plurality of tracking records are created by sending a plurality of cookies to the plurality of users, wherein a cookie of the plurality is received by a computing device related to a unique user of the plurality of users. In another alternative, the method further includes capturing the at least a portion of the plurality of tracking records from a first user computing device belonging to the first users, wherein at least one of the plurality of cookies was stored in the first user computing device. In one alternative, the at least a portion of the plurality of tracking records captured are sent by the tracking pixel to a server. In another alternative, the correlating occurs at the server. Alternatively, the server analyzes the subset of the actions and awards attribution for an occurrence of an event as related to the loading of the vendor webpage. In one alternative, the event is a sale and the vendor webpage is a confirmation page. In another alternative, a marketing tracking pixel on each of the plurality marketing webpages performs the creating. In another alternative, the marketing tracking pixel captures information concerning a user of the plurality of users accessing a webpage of the plurality of marketing webpages.

In one embodiment, a system for collecting and correlating information about user interactions with a plurality of websites includes a tracking pixel, placed on a vendor website, for tracking actions of a user in respect to a transaction; a server for receiving information from the tracking pixel; a vendor webpage, for hosting the tracking pixel, wherein when the vendor webpage loads the tracking pixel is loaded, the tracking pixel captures and communicates a second set of information concerning the user, and the server is configured to receive the second set of information, compare the second set of information to a first set of information, and award attribution based on the comparison. In one alternative, the system includes a first advertiser tracking pixel, configured to capture the first set of information concerning actions of the user at a first advertiser webpage and communicate the first set of information to the server. In another alternative, the system includes a second advertiser tracking pixel, configured to capture a third set of information concerning actions of the user at a second advertiser webpage and communicate the third set of information to the server, wherein the server is further configured to compare the third set of information to the first and second sets of information. In another alternative, the system includes a first cookie, transmitted to the user from an advertiser webpage, the first cookie storing the first set of information. In another alternative, the tracking pixel captures the first set of information from the first cookie and communicates the first set of information to the server. In another alternative, the system includes a second cookie, transmitted to the user from an advertiser webpage, the second cookie storing a third set of information.

In one embodiment, a method of collecting and correlating information about user interactions with a plurality of websites includes: adding a first cookie from a first website, the first cookie recording information concerning interactions of a user with the first website; adding a second cookie from a second website, the second cookie recording information concerning interactions of the user with the second website; initiating a tracking pixel on a third website; capturing information from the first and second cookies; and determining a first contribution of the first website and a second contribution of the second website to interest in the third website. In one aspect, the tracking pixel is initiated upon the purchase of an item by the user on the third website. In another aspect, the tracking pixel is an image url. In yet another aspect, the tracking pixel is a javascript api. In another aspect, the tracking pixel is an IFrame. In another aspect, the first website and the second website are item aggregators. In another aspect, the information concerning the interactions stored in the first and second cookies each contain at least one interaction related to the item. In another aspect, the information concerning the interactions stored in the first and second cookies each contain a time and date at which the respective cookie was created. In another aspect, the first and second contributions depend on the time and date of the first and second cookies. In another aspect, the time and date of the first cookie is more recent than the time and date of the second cookie, and wherein the first contribution is determined to be greater than the second contribution. In another aspect, the time and date of the second cookie is with a time and date limit and wherein the second contribution is determined to have a value greater than zero. In another aspect, at least one informational field is captured from the third website concerning the purchase. In another aspect, at least one informational field is selected from the group consisting of a city of the user, a state of the user, a unique user id, an order number, an item sku, an amount paid, a quantity number, a coupon code, a time of purchase, an address, a phone number, and an email address.

In another embodiment, determining the origins of sales leads includes: creating, with a tracking pixel when a website is accessed, a first user view, wherein the first user view is a record of a first user visiting a website to view an item, wherein the first user view contains information concerning a first originator of the first user view; creating, with the tracking pixel when the website is accessed, a second user view, wherein the second user view is a record of a second user visiting a website to view the item; determining a likelihood that the second user and the first user are the same user; and awarding attribution to the first originator for the second user view, based at least in part on the likelihood. In one aspect, the second user view contains information concerning a second originator of the second user view. In another aspect, the information concerning the first originator is stored in a cookie and the cookie is accessed by the tracking pixel. In another aspect, the cookie is stored in a local memory of the first user. In another aspect, the information concerning the first originator is obtained from a gateway used to access the website. In yet another aspect, the determining is based on a first unique user id given to the first user and a second unique user id given to the second user. In another aspect, the first and second unique user ids are the same and the likelihood is set to 1. In another aspect, the first and second unique user ids are associated with the browser of the first and second users. In yet another aspect, a time and date are associated with the first user view. In another aspect, the awarding is based in part on the time and date. In yet another aspect, the time and date are outside a range and, therefore, the attribution is set to zero.

### BRIEF DESCRIPTION OF THE DRAWINGS

FIG. 1 is a system diagram of one embodiment of the Online Marketing Payment Monitoring Method and System;

FIG. 2 is a flow chart of one embodiment of the Online Marketing Payment Monitoring Method;

FIG. 3 is an activity diagram for one embodiment of the Online Marketing Payment Monitoring Method and System;

FIG. 4 is a flow chart for one embodiment of a fraud elimination method of the Online Marketing Payment Monitoring Method and System;

FIG. 5 is an example summary of cost per click ads for a particular shopping channel and the result of ads within that shopping channel; and

FIG. 6 is an example of a summary of the leads generation for a particular item.

### DETAILED DESCRIPTION OF THE INVENTION

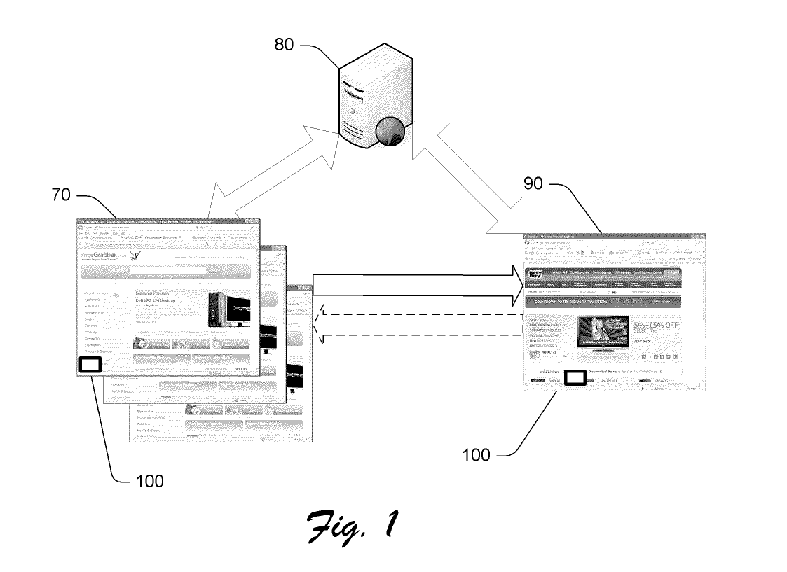

Referring to FIG. 1, in one embodiment of an Online Marketing Payment Monitoring Method and System, an object referred to as a tracking pixel 100 is used to determine online marketing payments. A tracking pixel may also be known as a web beacon, web bug, as well as numerous other names known to those skilled in the art. The tracking pixel may take various forms such as an image url, IFrame, or javascript image url, or other suitable form.

Three basic scenarios frame the Online Marketing Payment Monitoring Method and System. These scenarios are organized around the location where information is captured during the online shopping experience. As shown in FIG. 1, the three main capture points for information are: a website of the vendor 90; a website of aggregator 70 (also known as an advertiser or marketer); and a redirecting intermediary and information collector 80 through which a user is directed from an aggregator to a vendor. The intermediary and information collector 80 may be made up of a single server or a variety of servers. The redirection features and the information collection features may be separated, such that they reside on different servers or different groups of servers (this may be done for privacy and impartiality reasons). By utilizing these capture points in the proper combinations, the aggregators whose leads actually lead to the ultimate sale of a product (or service) can be more truly tagged and determined. It is important to note that FIG. 1 is intended to convey conceptually where the tracking is occurring. Tracking occurs when the user visits a website or when a request from the user is routed through an intermediary. The website of the vendor and the website of the aggregator are hosted by servers, and information is physically captured at the user's access device (computer, PDA, web enabled cell phone, other portable device allowing internet access, such as a Wi-Fi enabled device (like the iPod touch) or device accessing a network via Bluetooth, etc.) and the servers providing hosting, along with other intermediaries.

In one embodiment, a vendor (and website provider) interested in utilizing the tracking, payment, and monitoring systems and methods disclosed in the present application embeds a tracking pixel 100 (FIG. 1) in various webpages of their websites. This methodology is primarily focused on obtaining information at the website of the vendor. According to FIG. 1, the user visits aggregator websites 70 and then visits vendor website 90 (likely by clicking on a link directing the user to vendor website 90; however, this is not absolutely necessary). Information concerning the visit then flows via firing of the tracking pixel to redirecting intermediary and information collector 80. The redirecting intermediary and information collector 80 may send notification of a sale to the proper website of the aggregator websites 70. The webpages embedded with the tracking pixels are typically those pages that the website provider desires to track, i.e., those pages related to actions the vendor deems desirable (buying products, researching products, etc.). The webpages may include, but are not limited to, product manual pages, item descriptions, specialized marketing pages, checkout or cart pages, and purchase pages received upon checkout. Since, in one application, the website operator may track leads, impressions, and the like, the tracking pixel 100 may appear on primarily product checkout pages and item description pages. When a webpage containing the tracking pixel is loaded, the tracking pixel “runs” and the embedded software (in some alternatives JavaScript) performs the specified functions.

In another embodiment, and in all of the description herein, the aggregator may be replaced by the provider of an advertisement. Advertisements may include:
Floating ads: An ad which moves across the user's screen or floats above the content;
Expanding ads: An ad which changes size and which may alter the contents of the webpage;
Polite ads: A method by which a large ad will be downloaded in smaller pieces to minimize the disruption of the content being viewed;
Wallpaper ads: An ad which changes the background of the page being viewed;
Trick banners: A banner ad that looks like a dialog box with buttons (it simulates an error message or an alert);
Pop-ups: A new window which opens in front of the current one, displaying an advertisement or entire webpage;
Pop-unders: Similar to a Pop-Up except that the window is loaded or sent behind the current window so that the user does not see it until they close one or more active windows; and
Video ads, etc.

Tracking cookies or other tracking measures may be added at one or more of the various points in the advertising/search process as well as including, but not limited to, upon ad presentation, upon clicking on an advertisement, upon performing a query with an aggregator, etc.

Furthermore, although the systems and methods are primarily focused CPC (cost per conversion, where the conversion is a sale), other actions (and the attribution therefore) may be tracked by the present systems and methods. These include, but are not limited to, CPM (Cost Per Impression) which is the situation in which advertisers pay for exposure of their message to a specific audience (in this context, advertisers may be interested in the audience receiving a particular impression at particular set times or with particular events); CPV (Cost Per Visitor) or (Cost Per View in the case of Pop-ups and Pop-unders) where advertisers pay for the delivery of a Targeted Visitor to the advertisers website; or CPC (Cost Per Click), also known a pay per click (PPC). Advertisers pay every time a user clicks on their listing and is redirected to their website. They do not actually pay for the listing, but pay only when the listing is clicked on. This system allows advertising specialists to refine searches and gain information about their market. Under the pay per click (PPC) pricing system, advertisers pay for the right to be listed under a series of target rich words that direct relevant traffic to their website, and pay only when someone clicks on their listing which links directly to their website. CPC differs from CPV in that in the former, each click is paid for regardless of whether the user makes it to the target site. CPA (Cost Per Action) or (Cost Per Acquisition) advertising is performance based and is common in the affiliate marketing sector of the business. In this payment scheme, the publisher takes all of the risk of running the ad, and the advertiser pays only for the amount of users who complete a transaction, such as a purchase or sign-up. This is the best type of rate to pay for banner advertisements and the worst type of rate to charge. Similarly, CPL (Cost Per Lead) advertising is identical to CPA advertising and is based on the user completing a form, registering for a newsletter, or some other action that the merchant feels will lead to a sale.

In one embodiment, the tracking pixel functions within the context of the online marketing and sales of services and products from cookie information. The basic framework of online marketing and sales may be described as including vendors, aggregators, and manufacturers. In brief, vendors list products for sale and have systems that allow for the purchase of these items through their website. Aggregators collect information concerning the listing of a plurality of products from a plurality of vendors. Typically, aggregators and vendors agree to a compensation arrangement whereby the vendor will pay the aggregator for per impression or sales lead driven to the vendor's site. Manufacturers may list information concerning their products and include links to vendors who are selling those products.

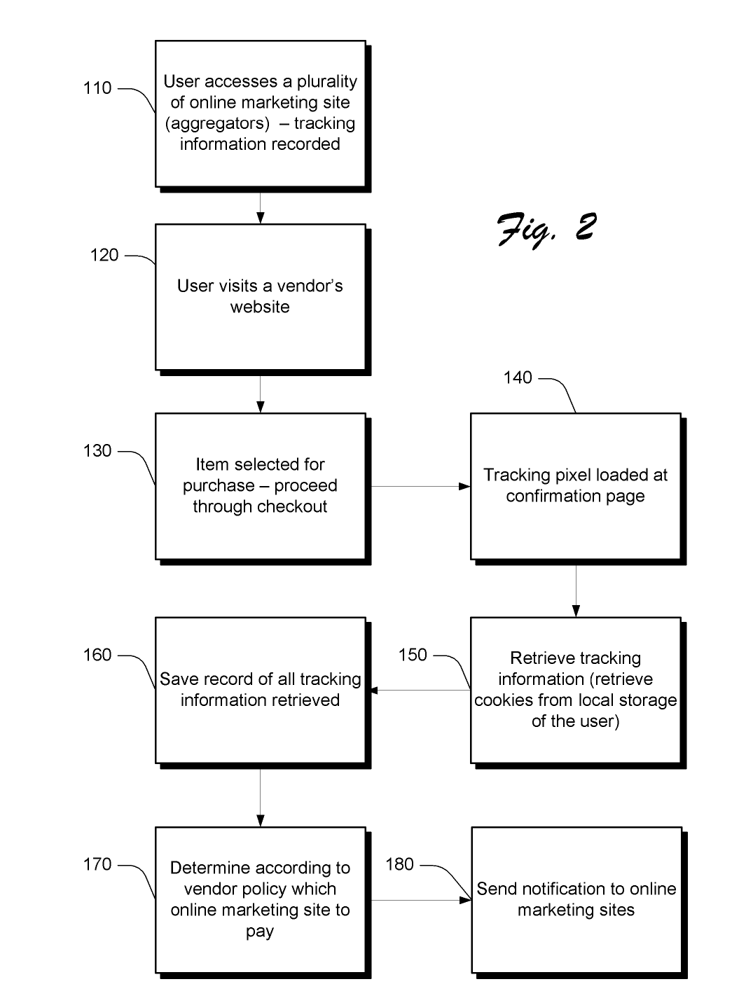

To allow for a vendor to track where a lead came from, aggregators may send cookies to the browser of a user. The basic procedure for an embodiment of online marketing payment monitoring is shown in FIG. 2. In step 110, a user accesses a plurality of online marketing sites, using a browser, in order to search for a product of interest. Each of the online marketing sites utilized by the user saves a cookie or other tracking item to a local memory location associated with the user (in many instances, this will be the user's hard drive). In step 120, the user visits a vendor's site. In step 130, the user selects an item for purchase and proceeds through checkout. In this step, the “buy” page is loaded, indicating that the transaction has been completed. In step 140, the tracking pixel is loaded and executed. In step 150, information from the cookies stored in the local memory of the user is retrieved. Alternatively, tracking information can be retrieved from other sources as described below. In step 160, a record of all cookies retrieved and other information related to the sale is stored for later review by the vendor. In step 170, it is determined, according to a vendor's policy, which online marketing sites should be paid. In step 180, notification of the sale is sent to the online marketing sites as determined in step 170.

The analysis of the cookies performed by the present system is a significant improvement over previous systems, as shown in FIG. 2. In previous systems, upon accessing the buy page, all valid cookies were notified that a sale had occurred. Then all notified cookie providers/aggregators would bill the online vendor site for providing the lead for the sale resulting in multiple bills for one sale. As can be seen in FIG. 1, data flow between the vendor website 90 and the aggregator website 70 is shown. The broken arrow flowing from the vendor website 90 to the aggregator website 70 indicates that, in many embodiments of the online marketing payment method and system, data no longer flows directly from vendor website 90 to aggregator websites 70 as it did in many prior art systems. Instead, it flows to an intermediary first (redirecting intermediary and information collector 80) where information can be reconciled in order to ensure proper attribution for a sale is given. This can help prevent fraud and multiple payments.

Multiple procedures are available for determining which cookie or cookies should result in the attribution of a lead and, therefore, payout under the contract between the vendor and the aggregator. One payment rule may be to pay the aggregator (or online marketing site) that is closest in time to the sale if a valid cookie exists. Other rules may allow for the payment of multiple aggregators, thereby allowing the possibility for sales “assists.” One such rule may be to pay the closest in time aggregator a defined amount and pay another aggregator a defined amount if they are within a certain time period of sale. Alternatively, the rule may be to pay the assisting aggregator if they are within a certain period of time of the closest in time aggregator. Of course, any number of potential parties may be included in the payment rule scheme and may be scheduled to be paid according to any time period combination.

In one alternative, step 170 may include multiple steps. Usually as part of an agreement with an aggregator or marketing site, a vendor agrees to host the tracking pixel of the aggregator or marketing site. Instead of hosting multiple tracking pixels, the user hosts a single tracking pixel 100 of the Online Marketing Payment Monitoring Method and System. The tracking pixel 100 is able to fire any combination of tracking pixels that the vendor has agreed to install on his website. The tracking pixels fired are related to the rules that the vendor sets out for the fair payment for leads.

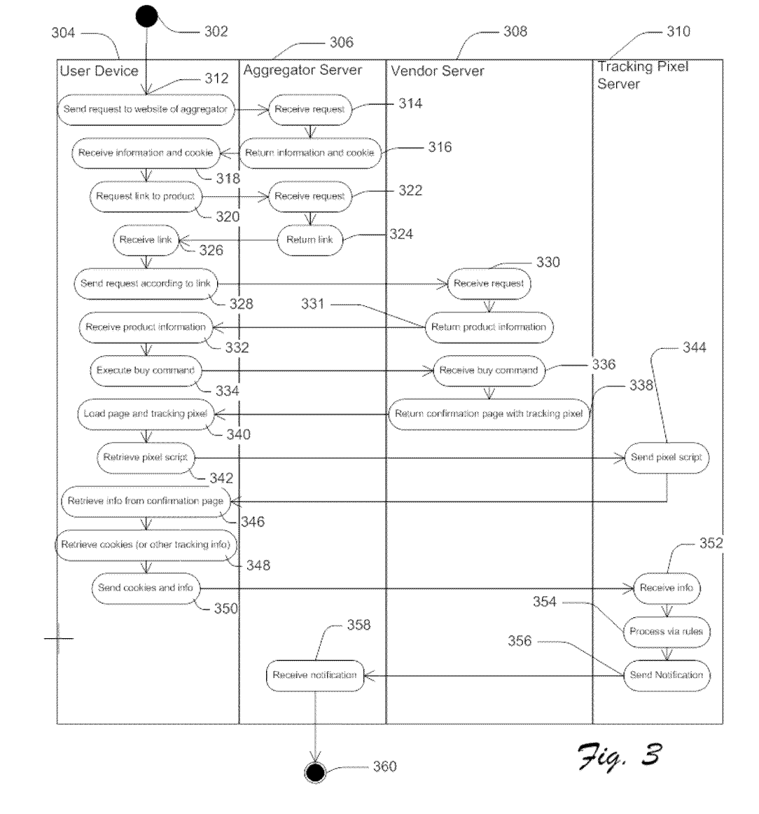

FIG. 3 shows an activity diagram for one embodiment of the Online Marketing Payment Monitoring Method and System. The activity diagram of FIG. 3 is a UML (unified modeling language)-based diagram; UML is a standard modeling language used for developing object oriented software, such as java. Swimlanes for the User Device 304, Aggregator Server 306, Vender Server 308, and Tracking Pixel Server 310 are shown to indicate where action states are occurring. At start point 302, a user begins the process of online shopping. Typically, the user will utilize the website of an aggregator (hosted on Aggregator Server 306) to identify where to purchase an item. As described above, the user typically will utilize multiple aggregator servers or click on multiple hosted ads. In action state 312, the user sends a request to the Aggregator Server 306 from the User Device 304. This request is typically a search for a particular item that the user is interested in purchasing. At action state 314, the request is received and processed and information is returned according to the search of the user in action state 316. The returned results are typically in the form of a list of links (and additional information) that will direct the user to a webpage of the product. At 316, the Aggregator Server 306 also returns a cookie to the User Device 304.

In alternative embodiments (described below), the Aggregator Server 306 may return a tracking pixel with the search results page that will fire upon loading by the User Device 304. This tracking pixel may capture information about the user and return it to the Tracking Pixel Server 310, where it may be captured and later correlated against purchase information. This process is described in further detail below.

Continuing with FIG. 3, in action state 318, the user receives the search results and information. The user requests a link to the product in which they are interested in action state 320, and the Aggregator Server 306 receives the request in action state 322 and processes it. A link is returned in action state 324. In one alternative, additional tracking data may be captured at this stage by sending a tracking pixel or an additional cookie. Also, in another alternative, action states 320, 322, 324, and 326 may be omitted and, instead, the information received in action state 318 may include links. In action state 326, the link is received and a request is sent according to the link in action state 328, which also may, in some embodiments, be described as the user clicking on the link.

In action state 330, the request is received at a Vendor Server 308; and in action state 331, the product information (product page offering the item for sale) is returned. In an alternative embodiment, the link received in action state 326 may redirect the user through the Tracking Pixel Server 310 or another server not shown in FIG. 3 but generally described as the intermediary and information collector 80 in FIG. 1, so that the firing of this link may be tracked. In this case, the user is immediately redirected to the Vendor Server 308 and site, but information concerning the user and User Device 304 accessing the link is recorded. More description of this embodiment may be found below.

In action state 332, the product information is received, generally offering the user the chance to buy the product. In action state 334, the user executes a buy command. Note that action states 332 and 334 may embody a multi-step process, whereby the user adds the product to a cart and proceeds through checkout, entering information and sending information to the Vender Server 308 at multiple points. In one alternative, at any step in the process, the Vendor Server 308 may send a tracking pixel along with other information to the User Device 304. When the User Device 304 loads this pixel, information may be captured as described above and below. As described below, many vendors may wish to track when items are added to the purchase cart or other occurrences.

Continuing with FIG. 3, in action state 336, the buy command is received at the Vendor Server 308. The purchase is processed and a confirmation page is returned in action state 338. This confirmation page preferably includes a tracking pixel. The User Device 304 receives and loads the confirmation page and the tracking pixel in action state 340. Upon loading the tracking pixel, typically a link is loaded directing the User Device 304 to Tracking Pixel Server 310. In action state 342, the pixel script is retrieved (sent by the Tracking Pixel Server 310 in action state 344). The tracking pixel directs the user device to retrieve and send information and cookies in action states 346, 348, and 350. The information is received at action state 352 and processed according to the vendor rules for payment of leads in action state 354. These rules can include a variety of procedures and are described above and below. These rules can include correlating presently captured information with previously captured information concerning user's usage of aggregators (in cases where aggregators send tracking pixels with search results, etc.). Note that, in many cases, cookies from multiple aggregators (or other tracking information from multiple aggregators) must be reconciled at this point.

When it is determined which party or parties should receive attribution for the sale, notification is sent to the proper parties in action state 356 and notification is received by the aggregator in action state 358. The process generally ends at end 360; however, at this point, the aggregator may proceed with billing procedures. It is important to note that the User Device 304, Aggregator Server 306, Vendor Server 308, and Tracking Pixel Server 310 represent generalized servers; and each location may in actuality be composed of one or more servers that may be distributed across a variety of networks. Generally, the Servers 306, 308, and 310 are meant to represent functional units that send and receive information over the Internet or other network and do not have to be contained in a single “server.” Furthermore, the activity diagram of FIG. 3 is simply an example of how the present system and method may be implemented in one embodiment.

In addition to using tracking cookies for the establishment of leads, a number of other techniques may be implemented by the tracking pixel 100. In one embodiment, a tracking pixel may utilize accounts the user may have with aggregators. In this embodiment, upon purchase, information concerning the purchase is captured. This information may include data such as information about the product purchased (product number, price, coupon code, etc.) and information concerning the purchaser identification (the address that the item will be shipped to, including subcomponents of the address, name, and other identifying information). This information may then be compared against the user logs of aggregators. If sufficient information is matched between the user log of the aggregator and the information captured on purchase, it may be determined that the aggregator should be paid for providing a lead.

Lead tracking based on user login and profiles may encounter significant privacy or user privacy agreement issues. Therefore, aggregators may provide this information using an anonymous user identifier, or information from both aggregators and tracking pixel managers may be provided to a secure third party server which may process and correlate the data.

In yet another embodiment, the user may be tracked according to means other than a third party cookie. Tracking mechanisms may include the IP address of the user, a combination of the IP address and the browser identification (user-agent), session IDs in a URI (uniform resource information) query or cookie, or a first party cookie from the pixel manager. These methodologies may be more effective, since many users do not allow the installation of third party cookies. The use of any of these mechanisms generally requires the usage of a tracking pixel on both the site of the vendor and the aggregator.

According to this embodiment, a tracking pixel is placed on the website of the aggregator. When the user accesses the aggregator's website, identifying information is captured concerning the user and the interaction. This identifying information is transferred by the tracking pixel to a centralized server (or group of related servers). When the user buys a product, the tracking pixel placed on the website also captures identifying information. The information is also transferred to a centralized server. The collected information then may be correlated according to a rules set and attribution for sales (or other events) is determined.

For example, the user may be tracked by IP address. A user visits the website of an aggregator. The tracking pixel 100 on the website of the aggregator fires when the page is accessed and reports information including the IP address of the user to the redirecting intermediary and information collector 80. The user then buys an item from a vendor website 90. The tracking pixel 100 on the buy page of vendor website 90 then fires. Information concerning the transaction is collected, including the IP address of the user, and sent to redirecting intermediary and information collector 80. A rule set is applied and, in this case, the IP addresses are correlated. The rule set also checks to see if the transaction at the aggregator site is recent enough to receive attribution for the sale.

In another example, the user is tracked according to a first party cookie. When the user visits an aggregator website 70, the tracking pixel 100 checks to see if a cookie is present for the user identifying them with a unique (or semi-unique) identifier. If the cookie exists, it is read and the occurrence of the user visiting the aggregator website is logged to the redirecting intermediary and information collector 80. Other pertinent information may be logged including the time of access and other information according to the privacy policy. Such information may include search queries, browsing history on the site, and all other available information. If the cookie does not exist, a cookie is created and a unique id is assigned to the user. The user may visit additional aggregator websites 70, and these additional visits and searches may be logged with redirecting intermediary and information collector 80. When the user visits a vendor website 90 and makes a purchase (or other transaction of interest), the tracking pixel 100 is fired, the cookie is read, and information is logged to redirecting intermediary and information collector 80. The visits of the user with the unique id are then analyzed to determine what aggregator websites 70 were visited and when according to the information previously logged. Aggregator websites 70 receive attribution according to the rules set (which may in one alternative indicate that the last in time aggregator website 70 receives attribution) and are notified by redirecting intermediary and information collector 80. Note that this scenario allows for any combination of parties to receive attribution, including a single or multiple parties.

Since the tracking pixels are easy to host on the website of a vendor or aggregator and the tracking pixels increase information and chance for payment while reducing fraud and the chance for redundant payments, both vendors and aggregators will be willing to host a tracking pixel. In one alternative, multiple tracking systems (cookies, IP address tracking, etc.) are used and all correlated against each other in order to most clearly identify the source of leads.

In another embodiment, leads from aggregators are redirected through the redirecting intermediary and information collector 80 and this occurrence is logged. In this embodiment, a vendor website owner subscribes to a feed management service, wherein information about the products the vendor has for sale are fed to the aggregators (in the format desired by the aggregators) for listing. The feed management service, as part of providing product information to the aggregators, provides a link to the product or service being sold at the website of the vendor. The feed management service composes the link provided such that the link redirects the user through the redirecting intermediary and information collector 80 and ultimately to the product page of the vendor. During this redirection, information concerning the user's usage of the aggregation website 70 is captured. Upon purchase of an item, the tracking pixel 100 is fired on the vendors' website, typically on the Thank You/Confirmation Page. Redirecting intermediary and information collector 80 receives notification of the purchase and identification information concerning the user. This identification information is matched against identification information captured during the redirection (such as IP address, session id, etc., including all identifiers described above). In practice, a variety (or all) of the techniques described above may be implemented in concert in order to best identify the source of leads.

The Online Marketing Payment Monitoring Method and System not only notifies the originator of a sale as determined by the rules, it also captures all parties potentially responsible for the occurrence of a sale in respect to a user. By analyzing this data, a vendor can determine what aggregators (marketing sites) are providing the best advertising opportunities. Even if a particular aggregator does not routinely receive attribution for sales under the attribution rules defined by a vendor, that aggregator may be responsible in some part for a sale. By using analytics, a vendor may identify how often a particular aggregator is involved at some point in generating interest that leads to the sale of a product or service.

In one embodiment, the Online Marketing Payment Monitoring Method and System includes fraud detection procedures and systems. In addition to using the wealth of collected information as described above in order to identify fraud, the usage of tracking pixels in places other than the buy page of the vendor can assist in identifying fraudulent activity. By placing tracking pixels on the landing page of a vendor website and cart page of the vendor website, a greater level of fraud detection is enabled. Many spyware/adware applications function by identifying the vendor page the user is visiting and thereafter placing tracking information that would tend to indicate that a specific aggregator had contributed to a user determining to buy a product from the vendor website. In one alternative, the adware, upon the user accessing a vendor site, may detect the vendor site and place a cookie that would tend to indicate that the user reached the website through the usage of a certain aggregator. Upon purchase, the vendor website sends a notification of sale to the aggregator because of the existence of the cookie, even though the cookie is not representative of a user using an aggregator to identify the vendor website. This is an undesirable result, since the vendor website pays a commission to the aggregator, even though the aggregator did not contribute to the sale.

By placing a tracking pixel on the landing page and the cart page, it can be determined when a user first accessed the vendor website, for example, according to the multiple identification techniques explained above. If an indication of lead generation or contribution (many times in the form of a cookie) is created after the user first accessed the vendor website, the aggregator is significantly less likely to have actually contributed to the sale. If an indication of lead generation or contribution is created after the user accessed a cart page and placed the eventually purchased item into a cart, it is even less likely that the aggregator contributed to the sale.

Therefore, upon the firing of the tracking pixel at purchase, the rules implemented by the tracking pixel will identify if an indication of lead generation or contribution was added during a prohibited time period. Such a prohibited time period may be between the user's first visit to the launch page of a vendor and purchase or between when the user adds the eventually purchased item to his cart and the purchase. Furthermore, in some cases, it may be desirable for this fraud protection to have an expiration period or the fraud period may be reset if the user visits the launch page or cart page again before purchase. For example, in a case where attribution should be awarded, a user may first visit the website of a vendor. The user then may access an aggregator website and search for the lowest price on an item. The aggregator website may lead the user back to the website of the vendor. The user then may purchase the item. In this case, no fraud has occurred; therefore, it might be considered rightful to attribute the sale to the aggregator.

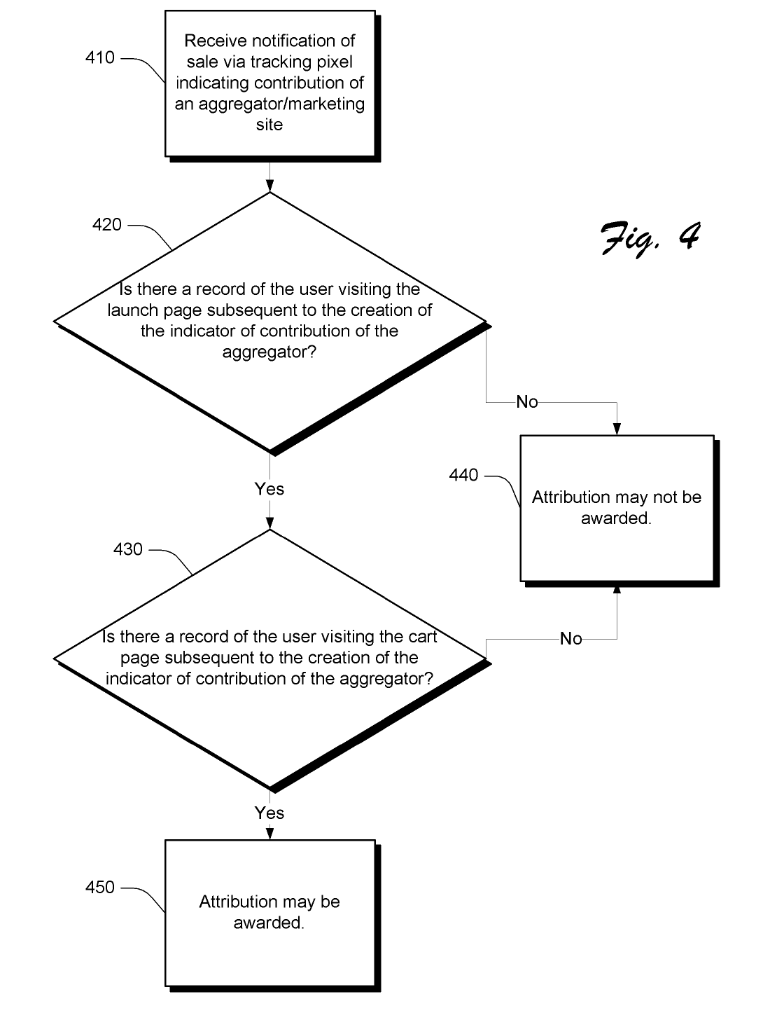

FIG. 4 shows an example of a methodology for fraud detection. In step 410, a notification is received via the tracking pixel that a sale has occurred. This notification indicates that an aggregator has contributed to the sale. Alternatively, records of user interactions may be correlated to determine whether an aggregator has contributed to the sale according to the above-described methods. In step 420, records in the redirecting intermediary and information collector 80 are searched to determine whether there is a record of the user visiting the launch page subsequent to the creation of the indication of aggregator contribution. If yes, it is inferred that the aggregator contributed to the sale. A second fraud check occurs at step 430. In step 430, if a record of the user visiting the cart page exists subsequent to the creation of the indicator of contribution, then flow continues to step 450 and it is concluded that the transaction is not fraudulent and that contribution can be awarded to the aggregator. If records of the user visiting the launch page and the cart page subsequent to the addition of an indicator of contribution do not exist, then the flow proceeds to step 440 and it is determined that attribution may not be awarded since the transaction is likely fraudulent.

Additionally, a tracking pixel may be placed on the start page of the vendor or other first page a user will come to if the user accesses the vendors' domain. A vendor may desire not to award contribution to an aggregator if a user visited the vendor's domain prior to the addition of an indicator of contribution. In this case, the vendor may also want to set an expiration period for the prohibition of awarding contribution based on a vendor's website, since scenarios may exist where the aggregator appears to make a significant contribution despite a user having already visited the start page of a vendors' website. For instance, a user may visit the start page of a vendor but not locate the product that is eventually purchased. The user may then later utilize an aggregator to identify the product that is eventually purchased and be directed to the website of the vendor. In this case, the vendor may desire to attribute credit for the sale to the aggregator.

In the above text, information is described as being collected by the server associated with the tracking pixel at various points in the process of searching for and purchasing items. By capturing, processing, and summarizing this information, vendors can obtain a wealth of information concerning the habits of their customers and the routes they take to identify and eventually purchase items. A report concerning the sales of a vendor based on the pixel tracking software described herein can include a variety of metrics including, but not limited to: all sales, when those sales occurred, demographics available about the purchaser (including purchase state, purchase address, shipping state, shipping address, email account holder, etc.), purchase price, coupon code used, shipping selected, leads that contributed to the sale and their temporal relation to the sale, attribution given, fraud detection measures (e.g., placement of third party cookies at time of visiting vendor site, etc.), or occurrence of other events (e.g., signup for membership, user account, etc.).

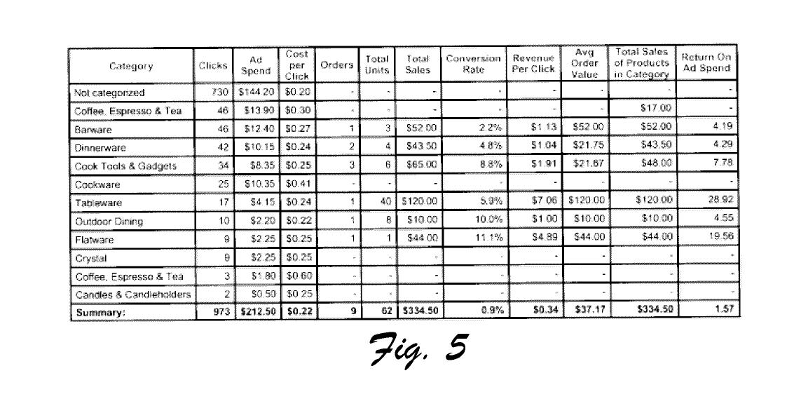

FIG. 5 shows a summary of cost per click ads for a particular shopping channel and the result of ads within that shopping channel. Such results can be generated by the Online Marketing Payment Monitoring Method and System. From the chart of FIG. 5, the advertiser can easily determine what advertisements are paying off for the period in question and make decisions about future adverting campaigns.

Since the invention captures information concerning the actions of a user at many different points in the marketing of a purchase process, detailed analytics can be generated concerning the purchase habits of users. In FIG. 5, results of an advertising campaign are shown in relation to categories of products sold by an online vendor. The number of clicks column relates to the number of times an advertisement or a referring link was clicked on, redirecting a user to the vendor's site. The Ad Spend column is the total cost spent for those advertisements in the related category. The Cost Per Click column is a calculation based on the number of clicks and the total ad expenditure for each category. The Orders column shows how many orders were made, and the Total Units column shows how many units were actually sold. The Total Sales column shows the total dollar amount of sales. The Conversion Rate column shows the percentage of clicks that resulted in an order. The Revenue Per Click column shows the amount of revenue divided by the number of clicks. The Average Order Value shows the total sales divided by the number of orders. The Total Sales Of Products In Category is the number of dollars in sales per category. The Return On Ad Spend is the ratio of Total Sales to Ad Spend.

Many of the above measures are important in measuring the effectiveness of an advertising campaign and allowing the vendor to identify where advertising dollars are yielding the highest returns.

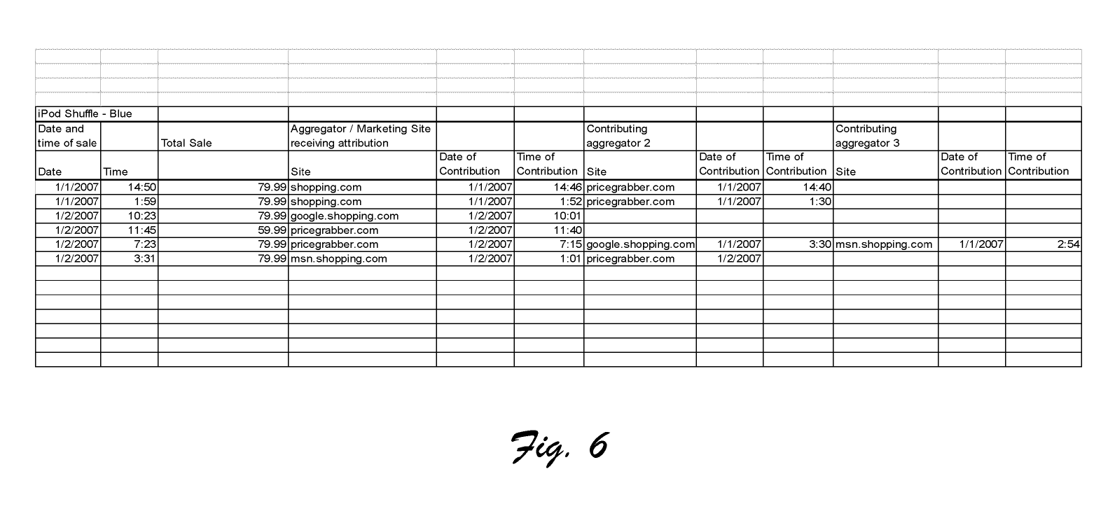

FIG. 6 shows a summary of the leads generation for a particular item, including the aggregator/marketing site receiving attribution and contributing sites. Note that the list of the contributing sites could be much longer. From this report, the vendor could determine which advertising is yielding the best results. Also, important contributing sites that did not ultimately receive attribution for the sale can be determined. FIG. 6 shows a summary for a particular product of a Vendor, the iPod Shuffle in blue. This summary only includes actions that resulted in sales, and not all lead generations and clicks as shown above. This chart is representative of the various types of data presentation that may be available according to the present system.

The Date And Time Of Sale column shows the date and time of the eventual sale. The Total Sale column shows the amount of sale. The Aggregator/Marketing Site Receiving Attribution column shows the marketing site that received attribution according to rules implemented in the tracking pixel. In this example, the vendor has not elected to award secondary or contributing attribution. The Contributing Aggregator 2 and 3 columns show additional aggregators that were detected at pixel firing as possible contributing advertisers. This type of resolution allows the vendor to identify those marketing sites that were not ultimately the sites receiving credit for the sale but may have vital importance to the sales process. The times are listed for all contributing aggregators so that the vendor may establish when advertisements occurred in time in order to help establish their significance. In the present case, pricegrabber.com may be of primary importance to the vendor, even though the site was not responsible for the majority of sales, since, in all cases except for one, pricegrabbber.com was accessed at some point in the purchase process. In alternatives, graphs and charts may be created showing the proximity in time of particular marketing sites to the sale of products. This represents only one small sample of the data that can be presented. Any combination of relationships between a marketing site and events occurring on the vendor's website may be shown and depicted in graphs and tables according to the Online Marketing Payment Monitoring Method and System. Events may include, but are not limited to: page accesses, membership signups and account creation, additions to a shopping cart, sales, product manual inspections, etc. The Online Marketing Payment Monitoring Method and System can further generate and present to the user tables showing what percentage of sales a particular site received attribution or contributed as a secondary site to the sale so that the vendor can determine the most effective advertising campaigns.

Additional metrics can be gathered that allow the vendor to identify if there is an issue at some point in the sales process. For instance, do shoppers add an item to the cart but then fail to complete checkout routinely? Since tracking pixels may be inserted at a variety of points, detailed data can be collected concerning all aspects of the shopping experience. For instance, by placing tracking pixels at the splash/landing page, cart page, and purchase confirmation page, the vendor may track what leads from which sites resulted in only product views at the splash page, which resulted in cart additions, and which resulted in purchases. Such detailed resolution can help establish potential sticking points in the purchase process. Corrective action may be taken by the vendor, including changing purchase procedures or policies. While such tracking may not instantaneously solve marketing issues, the tracking and collected data can assist the vendor in identifying where to look.

Although the above sections describe the Online Marketing Payment Monitoring Method and System in language specific to structural features and/or methodological operations or actions, the implementations defined in the appended claims are not necessarily limited to the specific features or actions described. Rather, the specific features and operations for the Online Marketing Payment Monitoring Method and System are disclosed as exemplary forms of implementing the claimed subject matter.

1. A method of collecting and correlating information about user interactions with a plurality of websites, the method comprising:
(a) creating a first tracking record of first actions of a user in relation to a first advertising webpage;
(b) loading a tracking pixel and a vendor webpage;
(c) capturing a second tracking record concerning second actions by the first user on the vendor webpage using the tracking pixel; and
(d) correlating the first and second tracking records to determine the contribution of the first advertising webpage to the second actions of the first user.

2. The method of claim 1 wherein the first tracking record is created by sending a first cookie to the user, wherein the first cookie is received by a computing device related to the user.

3. The method of claim 1, further comprising:
(e) capturing the first tracking record from the computing device belonging to the first user, wherein the first tracking record is captured from the first cookie.

4. The method of claim 3 wherein the first tracking record captured in (e) is sent by the tracking pixel to a server.

5. The method of claim 4 wherein the correlating of (d) occurs at the server.

6. The method of claim 5 wherein the server analyzes the first and second tracking records and awards attribution for an occurrence of an event related to the loading of the vendor webpage.

7. The method of claim 6 wherein the event is a sale and the vendor webpage is a sale confirmation page.

8. The method of claim 7 wherein a third tracking record related to a second advertising webpage is created.

9. The method of claim 8 wherein the third tracking record is a second cookie.

10. The method of claim 9 wherein the server also analyzes the third tracking record in relation to the first and second tracking records.

11. The method of claim 10 wherein the attribution is awarded to a contributing website for the first and second advertiser webpages based on the temporal occurrence of the first and third tracking records.

12. The method of claim 1 wherein an advertising tracking pixel on the first advertising webpage performs the creating of (a) and sends the first tracking record to a server.

13. The method of claim 12 wherein the advertising tracking pixel captures information concerning the user accessing the first advertising website.

14. The method of claim 13 wherein the correlating of (d) occurs at the server.

15. The method of claim 14 wherein the server analyzes the first and second tracking records and awards attribution for an occurrence of an event related to the loading of the vendor webpage.

16. A method of collecting and correlating information about user interactions with a plurality of websites, the method comprising:
(a) distributing a plurality of first tracking pixels to a plurality of marketer websites;
(b) capturing a first set of information concerning actions of a plurality of users via the plurality of first tracking pixels;
(c) firing a tracking pixel on a vendor webpage;
(d) capturing a second set of information concerning a transaction by a user on the vendor webpage; and
(e) correlating the first set of information to the second set of information to determine a subset of the actions of the plurality of users related to the transaction.

17. The method of claim 16 wherein the correlating of (e) includes identifying a set of the actions of the plurality of users that correspond to the user and including those in the subset.

18. The method of claim 17 wherein the identifying is based on captured IP addresses.

19. The method of claim 17 wherein the identifying is based on captured user-agent information.

20. The method of claim 17 wherein the identifying is based on captured session IDs.

21. The method of claim 17 wherein the identifying is based on captured cookie information.

22. The method of claim 16 wherein the transaction is the purchase of an item.

23. The method of claim 16 wherein the actions are product searches at a marketing website.

24. The method of claim 16 wherein the actions are the reception of advertisements.

25. A method of collecting and correlating information about user interactions with a plurality of websites, the method comprising:
(a) creating a plurality of tracking records concerning actions of a plurality of users in respect to a plurality of marketing webpages;
(b) loading a tracking pixel and a vendor webpage;
(c) capturing a second set of information concerning a transaction by a first user on the vendor webpage using the tracking pixel; and
(d) correlating at least a portion of the plurality of tracking records to the second set of information to determine a subset of the actions of the plurality of users related to the transaction.

26. The method of claim 25 wherein the plurality of tracking records are created by sending a plurality of cookies to the plurality of users, wherein a cookie of the plurality is received by a computing device related to a unique user of the plurality of users.

27. The method of claim 26, further comprising:
(e) capturing the at least a portion of the plurality of tracking records from a first user computing device belonging to the first users, wherein at least one of the plurality of cookies was stored in the first user computing device.

28. The method of claim 27 wherein the at least a portion of the plurality of tracking records captured in (e) are sent by the tracking pixel to a server.

29. The method of claim 28 wherein the correlating of (d) occurs at the server.

30. The method of claim 29 wherein the server analyzes the subset of the actions and awards attribution for an occurrence of an event is related to the loading of the vendor webpage.

31. The method of claim 30 wherein the event is a sale and the vendor webpage is a confirmation page.

32. The method of claim 25 wherein a marketing tracking pixel on each of the plurality marketing webpages performs the creating of (a).

33. The method of claim 32 wherein the marketing tracking pixel captures information concerning a user of the plurality of users accessing a webpage of the plurality of marketing webpages.

34. A method of collecting and correlating information about user interactions with a plurality of websites, the method comprising:
(a) adding a first cookie from a first website, the first cookie recording information concerning interactions of a user with the first website;
(b) adding a second cookie from a second website, the second cookie recording information concerning interactions of the user with the second website;
(c) initiating a tracking pixel on a third website;
(d) capturing information from the first and second cookies; and
(e) determining a first contribution of the first website and a second contribution of the second website to interest in the third website.

35. The method of claim 34 wherein the tracking pixel is initiated upon the purchase of an item by the user on the third website.

36. The method of claim 34 wherein the tracking pixel is an image url.

37. The method of claim 34 wherein the tracking pixel is a javascript api.

38. The method of claim 34 wherein the tracking pixel is an IFrame.

39. The method of claim 35 wherein the first website and the second website are item aggregators.

40. The method of claim 35 wherein the information concerning the interactions stored in the first and second cookies each contain at least one interaction related to the item.

41. The method of claim 35 wherein the information concerning the interactions stored in the first and second cookies each contain a time and date at which the respective cookie was created.

42. The method of claim 41 wherein the first and second contributions depend on the time and date of the first and second cookies.

43. The method of claim 42 wherein the time and date of the first cookie is more recent than the time and date of the second cookie, and wherein the first contribution is determined to be greater than the second contribution.

44. The method of claim 43 wherein the time and date of the second cookie is with a time and date limit and wherein the second contribution is determined to have a value greater than zero.

45. The method of claim 35 wherein at least one informational field is captured from the third website concerning the purchase.

46. The method of claim 45 wherein said at least one informational field is selected from the group consisting of a city of the user, a state of the user, a unique user id, an order number, an item sku, an amount paid, a quantity number, a coupon code, a time of purchase, an address, a phone number, or an email address.

47. A method of determining the origins of sales leads, the method comprising:
(a) creating, with a tracking pixel when a website is accessed, a first user view, wherein the first user view is a record of a first user visiting a website to view an item, wherein the first user view contains information concerning a first originator of the first user view;
(b) creating, with the tracking pixel when the website is accessed, a second user view, wherein the second user view is a record of a second user visiting a website to view the item;
(c) determining a likelihood that the second user and the first user are the same user; and
(d) awarding attribution to the first originator for the second user view, based at least in part on said likelihood.

48. The method of claim 47 wherein the second user view contains information concerning a second originator of the second user view.

49. The method of claim 47 wherein the information concerning the first originator is stored in a cookie and the cookie is accessed by the tracking pixel.

50. The method of claim 49 wherein the cookie is stored in a local memory of the first user.

51. The method of claim 47 wherein the information concerning the first originator is obtained from a gateway used to access the website.

52. The method of claim 47 wherein the determining of (c) is based on a first unique user id given to the first user and a second unique user id given to the second user.

53. The method of claim 52 wherein the first and second unique ids are the same and the likelihood is set to 1.

54. The method of claim 52 wherein the first and second unique user ids are associated with the browser of the first and second user.

55. The method of claim 47 wherein a time and date are associated with the first user view.

56. The method of claim 47 wherein the awarding is based in part on the time and date.

57. The method of claim 56 wherein the time and date are outside a range and, therefore, the attribution is set to zero.

58. A system for collecting and correlating information about user interactions with a plurality of websites, the system comprising:
(a) a tracking pixel, placed on a vendor website, for tracking actions of a user in respect to a transaction;
(b) a server for receiving information from the tracking pixel; and
(c) a vendor webpage, for hosting the tracking pixel, wherein when the vendor webpage loads, the tracking pixel is loaded, the tracking pixel captures and communicates a second set of information concerning the user, and the server is configured to receive the second set of information, compare the second set of information to a first set of information, and award attribution based on the comparison.

59. The system of claim 58, further comprising:
(d) a first advertiser tracking pixel, configured to capture the first set of information concerning actions of the user at a first advertiser webpage and communicate the first set of information to the server.

60. The system of claim 59, further comprising:
(e) a second advertiser tracking pixel, configured to capture a third set of information concerning actions of the user at a second advertiser webpage and communicate the third set of information to the server, wherein the server is further configured to compare the third set of information to the first and second sets of information.

61. The system of claim 58, further comprising:
(d) a first cookie, transmitted to the user from an advertiser webpage, the first cookie storing the first set of information.

62. The system of claim 61 wherein the tracking pixel captures the first set of information from the first cookie and communicates the first set of information to the server.

63. The system of claim 62, further comprising:
(e) a second cookie, transmitted to the user from an advertiser webpage, the second cookie storing a third set of information.
